(19) United States
(12) Patent Application Publication
(10) Pub. No.: US 2004/0098336 A1
(43) Pub. Date: May 20, 2004

(54) System for effecting orders for payment with identification by means of card data and fingerprint

(76) Inventor: Soren Flink, Enskede Gard (SE)

Correspondence Address: JACOBSON HOLMAN PLLC, 400 SEVENTH STREET N.W., SUITE 600, WASHINGTON, DC, 20004, US

(21) Appl. No.: 10/467,341

(22) PCT Filed: Feb. 19, 2002
(86) PCT No.: PCT/SE02/00285

(30) Foreign Application Priority Data
Feb. 22, 2001 (SE) 0100598-2

(51) Int. Cl. G06F 17/60

(52) U.S. Cl. 705/40

(57) ABSTRACT

A payment transaction system comprises payment terminals and a distribution centre that can be connected to teh terminal and to a monetary institution of financial establishment. Each payment terminal (11, 12, 13, . . . 1n) has its individual account (111, 121) in said monetary establishment (14, 16) and includes means (112, 122) for reading and sending card numbers to the distribution centre (10) for activating therein a first identity code corresponding to earlier sent card number, means for reading a second identity code (payer fingerprint), and means for opening said individual account (111, 121) in the monetary institution (14, 16) when agreement is found between the activated first identity code and the read second identity code. Each terminal also includes means (113, 123) for making the payment concerned, upon receipt of a balance signal from said individual account (111, 121) in the monetary institution (14, 16). Each payment terminal and the distribution centre include means (101 in FIG. 1; 111 in FIG. 3) for making a comparison between the activated first identity code and the read second identity code.

### FIELD OF INVENTION

The present invention relates to a system for effecting payment orders, and more particularly to such a system that includes a plurality of payment terminals and a distribution centre which can be connected to said terminals and also to at least one monetary institution or financial establishment (bank).

### DESCRIPTION OF THE BACKGROUND ART

Bills, invoices, and the lice, are paid at present through a bank giro service and a post giro service, for example. When such monetary institutions are founded on Internet solutions, they are based on digital code identification with the danger of the codes being acquired by unauthorised persons. These payment systems are also slow (so-called float days); it can take several days before a payment is finalised and reported.

The object of the present invention is to eliminate these and other drawbacks associated with such systems.

### SUMMARY OF THE INVENTION

In a system of the aforesaid kind, each payment terminal has an individual account with the monetary establishment. The system also includes means for:

reading and sending account numbers to the distribution centre for activation therein of a first identity code corresponding to the earlier sent card number;

reading a second identity code (a payer's fingerprint);

opening the individual account in the monetary establishment when agreement is found between the activated first identity code and the read second identity code; and

means for effecting payment of current payment orders upon receipt of an account balance signal from the individual account in the monetary institution.

These and other characteristic features of an inventive system will be apparent from the accompanying Claims.

The invention provides a novel payment system in which the user (the payer) pays, for instance, bills via the Internet directly from his own bank account to the bank account of the receiver (customer) without using a digital code or password. Instead of a digital code, there can be used a fingerprint (“reading and identity code”; see the aforegoing). It can perhaps be said that a fundamental feature of the invention resides partly in a combination of a smart card and fingerprint reading to achieve safe and simple identification, and partly in a direct transfer from account to account with immediate notification to the receiver via e-mail.

In brief, the system can be said to operate in the following manner:

The user (the payer) logs onto his/her own bank account via the Internet and with the aid of a smart card and fingerprint identification and can order payment to be made from his/her bank account to some other bank account. The number carried by the smart card results in the user's fingerprint being compared solely with his/her fingerprint earlier sent to and stored in a database. When there is agreement between these fingerprints, the path to the own account is opened therewith enabling payments to be made. The payment receiver is notified immediately by e-mail.

The transaction can be carried out with any personal computer whatsoever that can be connected to the Internet The distribution centre has computer power partly for storing a database in which a fingerprint, etc, is stored and partly for temporary storage of transactions until these transactions have been cleared between banks (possibly internally within one and the same bank). The system thus presumes certain co-operation with a bank or some other monetary institution or finance establishment (e.g. a chain of stores or gasoline companies).

The novel system is thought to be particularly suitable for newly established banks who may find difficulty in being included in existing payment systems. Moreover, the inventive payment system will satisfy the demand for an effective e-commerce payment system. The inventive system is also extremely secure as a result of the use of fingerprints and negates the risk of a user forgetting his/her digital code. It will also provide an interesting alternative for shop/card users.

### BRIEF DESCRIPTION OF THE DRAWING

The invention will now be described with reference to the accompanying schematic drawing, in which

FIG. 1 illustrates an inventive system that comprises payment terminals, a distribution centre and monetary institutions;

FIG. 2 illustrates a portion of a suitable example of a payment form; and

FIG. 3 illustrates a slightly modified payment terminal.

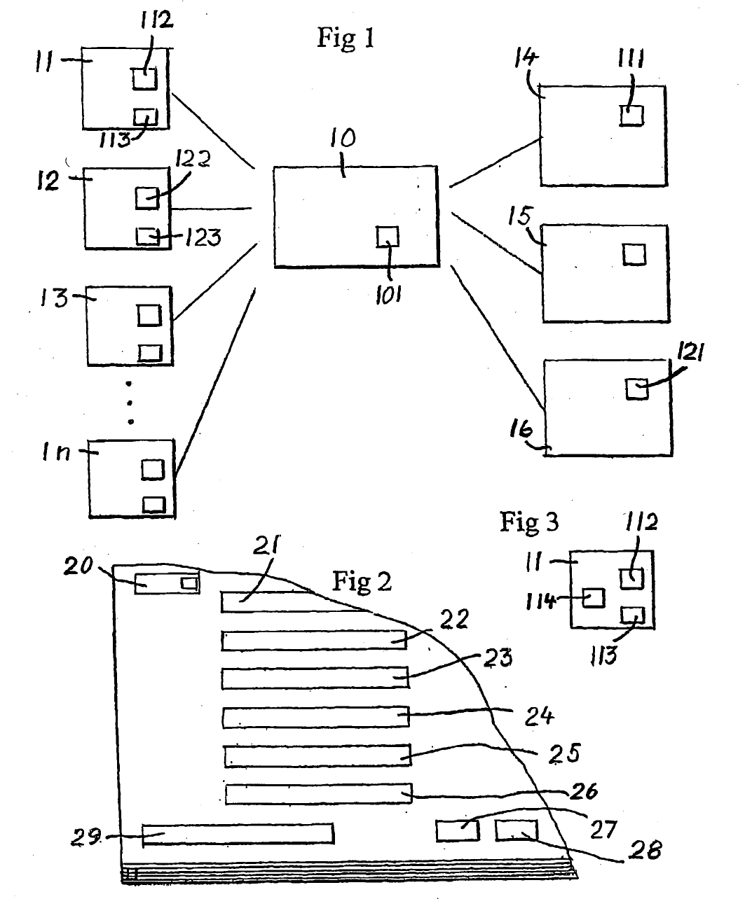

The system illustrated in FIG. 1 includes a plurality of payment terminals 11, 12, 13, . . . 1n and a distribution centre 10 that can be connected to the terminals and to monetary institutions (bans) 14, 15, 16.

Each payment terminal has its own account in a monetary institution. For example, the terminal 11 has an account 111 in the monetary institution 14.

Each payment terminal also includes a reader; i.e. in the present case the terminal 11 includes a device 112, the terminal 12 includes a device 122, and so on. These devices are designed respectively to read and send card numbers (carried by a smart card) to the distribution centre 10 for activating therein a first identify code corresponding to the earlier sent code number, to read a second identity code (payer's fingerprint) and to open the individual account 111 in the monetary establishment 14 when agreement is found between the activated first identity code and the read s cond identity code. This comparison between the two codes is made by a comparator 101 in the distribution centre 10.

Similarly, the terminal 12 has an account 121 in the monetary institution 16, and so on. Alternatively, the activated first identity code may be sent to the terminal 11 and there compared with the second identity code in a comparator 114 provided in said terminal; see FIG. 3.

Each payment terminal includes a device for making the payment concerned, upon receipt of a balance signal from the individual account in a monetary institution. The terminal 11 includes payment device 113, the terminal 12 includes payment device 123, and so on.

The distribution centre 10 is designed to store temporarily payment signals necessary for making payment transactions and received from a payment terminal, e.g. the terminal 11, and then send the signal to a monetary institution, e.g. the bank 14, which updates the balance in the account 111 and the balance in the receiver's account, and sends an e-mail to the receiver. Signal transmissions (information signals) between the distribution centre 10 and the monetary institutions 14-16 are preferably in an encrypted form.

The payment form (window) shown by way of example in FIG. 2 includes the following instructions/headings:

| | | |
|---|---|---|
| 20 = Choose receiver! | 21 = Receiver | 22 = Account |
| 23 = E-mail address | 24 = amount | 25 = Text |
| 26 = Payment date | 27 = Erase | 28 = Terminate! |
| 29 = Accepted for payment | | |

Selection of “Choose receiver!” results in permanent data being placed in respective rows 21, 22 and 23, this data referring to name, account number and e-mail address.

1. A system for effecting orders for payment, comprising a plurality of payment terminals and a distribution centre that can be connected to the terminal and to at least one monetary institution, characterised in that each payment terminal (11, 12, 13, . . . 1n) includes:
an individual account (111, 121) in the monetary institution (14, 16);
means (112, 122) for reading and sending account numbers to the distribution centre (10) for activation therein of a first identity code corresponding to the earlier sent card number; means for reading a second identity code (a payer's fingerprint), and for opening the individual account (111, 121) in the monetary institution (14, 16) when agreement is found between the activated first identity code and the read second identity code;
means (113, 123) for carrying out the payment concerned upon receipt of a balance signal from the individual account (111, 121) in the monetary institution (14, 16); and means (101 in FIG. 1; 114 in FIG. 3) in each payment terminal (11, 12 . . . ) and in the distribution centre (10) for making a comparison between the activated first identity code and the read second identity code.

2. A system according to claim 1, characterised in that the distribution centre (10) is designed to store temporarily payment signals necessary for carrying out payment transactions and received from respective payment terminals (11, 12, 13, . . . 1n) and to then send said signal to the monetary institution (14, 15, 16).

3. A system according to claim 2, characterised in that the distribution centre (10) is designed to send an information signal to the payment receiver informing said receiver that payment has been made, and also send to the payment terminal (11) a confirmation signal to the effect that the payment order has been carried out, subsequent to said payment having been made.
